(19) United States
(12) Patent Application Publication
(10) Pub. No.: US 2022/0290377 A1
(43) Pub. Date: Sep. 15, 2022

(54) A TUBE PACKAGE

(71) Applicant: Stora Enso OYJ, Helsinki (FI)

(72) Inventors: Henna Paakkonen Alvim, Gävle (PT); Kaj Backfolk, Lappeenranta (FI); Anders Moberg, Hammarö (SE)

(73) Assignee: Stora Enso OYJ, Helsinki (FI)

(21) Appl. No.: 17/754,157

(22) PCT Filed: Sep. 25, 2020
(86) PCT No.: PCT/IB2020/058979

§ 371 Date: Mar. 25, 2022

(30) Foreign Application Priority Data
Sep. 27, 2019 (SE) 1951095-7

(51) Int. Cl. D21H 27/30; D21H 19/82; D21H 19/04; D21H 19/22; B65D 65/42; B65D 65/40

(52) U.S. Cl. CPC D21H 27/30; D21H 19/824; D21H 19/04; D21H 19/22; B65D 65/42; B65D 65/40; B65D 2565/382

(57) ABSTRACT

The invention discloses a container for the packaging of compositions comprising water water-in-oil (W/O) emulsions and/or oil-in-water (O/W) emulsions, which container comprises a tube-formed body made from a paperboard comprising a fiber based substrate comprising a first ply forming a back ply, a second ply forming a top ply and a third ply forming at least one middle ply, wherein the fiber based substrate comprises CTMP. The compositions comprising W/O or O/W emulsions may be semi-solid compositions. The invention solves the problem of delamination of the multi-ply board connected to prior art solutions. In addition, the container provides the specific barriers needed to pack compositions comprising W/O- or O/W-emulsions. It further provides the required flexibility yet rigidity to be used in such tube-formed containers.

### FIELD OF THE INVENTION

The present invention relates to a tube package for packaging of personal care products comprising a water-in-oil (W/O) and/or an oil-in-water (O/W) emulsion.

### BACKGROUND

Dispensing tubes for semi-solids or viscous liquids, such as toothpaste, adhesives, paints or cosmetics are usually made from plastics to provide the required flexibility, formability and barrier properties. Dispensing tubes for personal care products faces its own unique challenges and limitations. There are high demands on the packaging materials used in the production of such tubes. The material needs to be formable and sealed without losing its barrier properties. It further needs to provide sufficient flexibility for the consumer or user to be able to squeeze out the content, but yet provide enough rigidity to withstand unintentional collapse during normal use. Personal care products, such as creams, lotions, and cleaning formulations products are oftentimes in the form of water-in-oil (W/O) or oil-in-water (O/W) emulsions, which require that the packaging material exhibits both grease-barrier and water-barrier properties. In addition, the packaging material needs to provide a high resistance against crack in folds and creases and/or other sealed regions.

Environmental concerns have increased the demand for higher content of renewable materials in the production of tube-formed containers. Attempts to use biodegradable or compostable materials in tube packaging have been made in the art. However, many of the proposed solutions in the prior art for making a more sustainable packaging material for tubes are based on paper based substrates or multiply paper. For more stiff base materials, such as paperboard, there is limited information available about their crack-resistance in folding or formability in more demanding 3D curvatures. Typically, the folding of such materials can be facilitated by creasing the region it concerns, whereas creases usually leads to increased risk for barrier failure.

WO2011034998 discloses a tube-formed container for semi-solid compositions made from a fibrous material such as paper that has been impregnated with a flexible biodegradable coating, which preferably has been disposed between each layer of the fibrous material.

WO2015061980 discloses a collapsible tube formed from a multilayer material comprising several polymer layers and a paper layer, which paper layer has a thickness of 30-100 microns.

One reason why fiber-based substrates used in the production of tube-formed containers usually are limited to one-ply papers or multilayer papers, is their flexibility and higher resistance to delamination. Multiply paperboards are usually made by joining or connecting the plies together at semi-solid conditions. This, on the other hand, leads to the problem of limited intermixing of the plies and hence a low ply bond and/or Scott Bond strength. One way to partly overcome this is to apply a boding agent between the plies. Such ply bond enhance the ply bond but does not necessarily provide sufficient formability and interply bond strength required for tube forming.

A tube-formed container for semi-solid compositions usually comprises a tube-formed body and, at the discharge end, a shoulder having a dispensing hole. At the opposite end, the tube-formed body is usually sealed. One problem connected to the use of a tube-formed body made from multiply paper or paperboard is the risk of leakage at the sealing where the plastic shoulder is sealed, e.g. by heat-sealing, to the body. Leakage in heat sealed areas may occur due to cracking caused by mechanical failure. In addition, folding and creasing of the packaging material may give rise to deteriorated barrier properties and may cause cracks or delamination. At the sealing point the multiply paper or paperboard is further subjected to forces that might cause delamination of the plies. At thermal sealing of a shoulder to a tube body made from multiply paperboard, heat is transferred to inner plies of the multiply structure. This may cause steam formation—and consequential blister forming—which might lead to delamination of the plies.

### SUMMARY OF THE INVENTION

The object of the invention is to provide a multi-ply fiber-based flexible but yet rigid tube-formed container for the packaging of water-in-oil emulsions and/or oil-in-water emulsions, which container does not involve the problems of delamination of the plies connected with the prior art solutions.

In a first aspect, the invention discloses a container for the packaging of compositions comprising water water-in-oil (W/O) emulsions and/or oil-in-water (O/W) emulsions, which container comprises a tube-formed body made from a paperboard comprising a fiber based substrate comprising a first ply forming a back ply, a second ply forming a top ply and a third ply forming at least one middle ply, wherein the fiber based substrate comprises CTMP. The compositions comprising W/O or O/W emulsions may be semi-solid compositions.

The inventors to the present invention have found that the weakest point of tube-formed containers made from multiply paperboard is not the actual seal between the tube-formed body and the shoulder, but rather the risk of delamination of the layers of the multi-ply paperboard, especially at the sealing area. The container according to the present invention solves this problem. Without wishing to be bound to a theory, it is believed that the use of CTMP in the multiply fiber based substrate forming the tube body decreases the thermal conductivity, whereby less heat from the sealing of plastic components (such as a shoulder) to the tube body is transferred to the inner plies of the structure. This decreases the risk of steam formation in the structure whereby delamination of the plies is avoided. The use of CTMP in the multiply fiber based substrate still gives the required strength properties, flexibility and rigidity to the container.

In a second aspect, the invention discloses use of a paperboard in the production of a tube-formed container for the packaging of compositions comprising water water-in-oil (W/O) emulsions and/or oil-in-water (O/W) emulsions, which paperboard comprises a fiber based substrate comprising a first ply forming a back ply, a second ply forming a top ply and a third ply forming at least one middle ply, wherein the fiber based substrate comprises CTMP.

### DETAILED DESCRIPTION

“Fiber based substrate” as used herein refers to an untreated or surface-sized paperboard substrate comprising cellulose fibers. Preferably, the fiber based substrate comprises 50 or 70, or 80, or 90 wt % cellulose fibers.

“Water-in-oil emulsion” as used herein refers to a system where water droplets are dispersed in oil.

“Oil-in-water emulsion” as used herein refers to a system where oil has been dispersed in water or aqueous phase.

“semi-solid compositions” as used herein refers to any compound having a viscosity of 50 to 2000000 Centipoise, preferably 2000-1000 Centipose.

“Scott Bond” as expressed herein is measured in accordance with Tappi 569.

“Z-tensile strength” as expressed herein is measured in accordance with SCAN P 80:98.

“Compression strength” as expressed herein is measured in accordance with SCAN P 46:83.

“Bulk” as expressed herein is measured in accordance with ISO 534:2005.

“Bending resistance” as expressed herein is measured in accordance with ISO 2493.

The invention relates to a tube-formed container made from a paperboard comprising a multi-ply fiber based substrate comprising chemi-thermal mechanical pulp (CTMP).

The tube-formed container of the invention preferably comprises a tube-formed body comprising a first and a second end. The first, lower, end is preferably sealed, using e.g. induction or heat sealing, while the second end may be connected to a shoulder having a dispensing hole for dispensing the product. The shoulder is typically connected to the tube-body using thermal sealing. The shoulder may further comprise a closure element. In accordance with the invention, the tube-formed body is made from paperboard, while the shoulder may be made from plastics such as polyethylene. The shoulder may also be made from a composite material comprising polyethylene and fibers. The container is especially suitable for packaging of personal care products, i.e. products used for health and beauty purposes including but not limited to cosmetics, shampoos and toothpastes. The container can further be used for packaging of semi-solid foods such as ketchup, tomato paste, mustards etc.

The invention further defines the use of a paperboard comprising the multi-ply fiber based substrate, which fiber based substrate comprises CTMP, in the production of a tube-formed container for the packaging of compositions comprising water water-in-oil (W/O) emulsions and/or oil-in-water (O/W) emulsions. The said tube-formed container preferably comprises a tube-formed body and a shoulder. The paperboard is used in the production of the said tube-formed body.

In embodiments, the fiber based substrate, used in the container and in the production of a tube-formed container, exhibits a Z-tensile strength of at least 350 kPa or at least 370 kPa or 380 kPa, such as between 350-500 kPa, or 350-400 kPa, or 370-500 kPa and a Scott Bond of at least 180 J/m², or preferably of at least 190 J/m², or at least 200 J/m², such as between 180-300 J/m² or 200-300 J/m².

It has been shown that a container made from a fiber based substrate exhibiting the said properties provides the required flexibility and yet enough rigidity not to collapse during normal use. Problems with cracks formed in the container during converting and delamination of the plies are further diminished. The ratio between Scott Bond and Z-tensile strength is preferably between 0.5 and 1, or 0.6-0.8.

The fiber based substrate may further exhibit a compression strength (MD) of at least 4 or at least 5 kN/m and a compression strength (CD) of at least 2 or at least 3 kN/m.

A fiber based substrate exhibiting the said properties can be made by combining the optimal fiber mix, strength additives and the process of bonding of the plies. Examples on how to provide such a fiber based substrate is given herein, while the skilled person realizes that there are further methods of providing such a fiber based substrate.

In embodiments, the fiber based substrate exhibits a bulk of at least 1 cm³/g, preferably at least 1.3 cm³/g. A high bulk further contributes to the low thermal conductivity and thereby reduces the risk of steam formation and delamination of the multiply board. In addition, a high bulk gives sufficient stiffness to the container. The fiber based substrate may further have a grammage of between 180-300 gsm, preferably between 200-250 gsm. The fiber based substrate may further have a thickness of at least 250 μm, such as between 250-350 μm.

The fiber based substrate may comprise CTMP in the third ply. CTMP (chemi-thermal mechanical pulp) may be of softwood or hardwood, preferably of softwood. The third ply of the fiber based substrate may comprise at least 50 wt % or at least 70 wt % or at least 100 wt % CTMP as calculated on the total fiber amount in the said ply. The first and second ply may comprise bleached or unbleached chemical pulp from softwood or hardwood. In a preferred embodiment the first ply, forming the back ply, is made from 100 wt % unbleached chemical softwood pulp and the second ply, forming the top ply, is made from 100 wt % bleached chemical softwood pulp, all percentages calculated on the total fiber amount of said ply. The fiber based substrate may comprise further middle plies, such as a fourth and a fifth ply arranged between the outer plies and the third ply. The fourth and fifth ply may comprise CTMP and/or chemical pulp.

In embodiments, the fiber based substrate comprises at least two plies bonded to each other without the application of any interply adhesive, such as starch, between the plies. In embodiments, the fiber based substrate does not contain any adhesive, such as starch, added between the plies. Starch is typically added between plies in a multiply paperboard in order to enhance the strength of the paperboard (especially Z-strength or Scott Bond). However, such starch addition between plies tend to form a film between the plies, whereby problems with blistering and delamination may occur. In addition, the use of starch does not provide the sufficient interplay bond or Z strength needed in the formation of tube-formed containers. Thus, the inventive combination of the use of CTMP in the fiber based substrate, the wet-on-wet forming and the avoidance of applying starch between the plies improves the ply-ply bonding of the fiber based substrate.

In embodiments, the fiber based substrate has been made by first forming a top ply on a wire using a first headbox, whereupon middle- and back plies are formed on the top ply using a second and a third successively arranged headbox. Preferably, there is no press section arranged between the headboxes. Headbox as used in this context is meant to define a traditional headbox used in paper or paperboard making. The middle- and top plies are preferably applied on the previously formed ply while this has a moisture content of at least 50 wt % or at least 70 wt % or at least 80 wt %. The consistency of each applied furnish is preferably between 0.1-10 wt %, or 0.3-5 wt %. By using the described wet-on-wet forming technique the plies of the fiber based substrate are strongly bonded to each other. In this way, a fiber based substrate exhibiting high resistance to delamination is provided, while no starch or adhesive is needed to be applied between the plies. In addition, this allows better infiltration and mixing in the ply interphases and, consequently, gives rise to a higher Z-strength. Further plies, e.g. a fourth and a fifth ply, may be similarly formed using fourth and fifth successively arranged headboxes.

The fiber based substrate may further comprise additives normally added to paper board, such as fillers, drainage and retention aids, softening agents, and strength additives. The strength additives may e.g. be chosen from the group of starch, protein, hemicellulose, PVAm, PDADMAC, nanocellulose or microfibrillated cellulose (MFC) and/or anionic or cationic polymers or combinations thereof. The anionic or cationic polymer is preferably chosen from the group of carboxymethyl cellulose (CMC), anionic polyacrylamide (APAM) or cationic polyacrylamide (CPAM) or combinations thereof. The said additive is preferably at least added to the third ply. The fiber based substrate may further comprise broke. In embodiments, at least one of the ply of the fiber based substrate is free from fillers. This way, a stiffer substrate can be made. The fiber based substrate may further be surface sized or pigment coated.

The paperboard used in the container may further comprise at least one barrier layer applied on a first surface of said fiber based substrate, most preferably on the back ply. The at least one barrier layer may comprise a first innermost barrier layer comprising polyolefin applied on the first surface of the fiber based substrate, a second barrier layer comprising a metal foil and/or ethylene vinyl alcohol (EVOH) and a third, outermost barrier layer comprising polyolefin, which third barrier layer forms an inner surface of the container adapted to be in contact with the content of the container. The Al foil may be attached to the barrier layers comprising polyolefin using tie layers. The polyolefin layers may have a thickness of 10-20 μm while the foil may have a thickness of 3-10 μm. Such a barrier structure provides high barrier against semi-solid compositions comprising W/O emulsions or O/W emulsions.

The paperboard to be used in the tube-formed container provides sufficient flexibility, rigidity and formability. In this context, formability means that the paperboard can be pressed or thermoformed into 3D shapes of higher curvature needed in tube-forming without the formation of cracks or decreased barrier properties.

In the following, an example of a paperboard suitable for the production of a tube-formed body of a container comprising the tube-formed body and a shoulder is further described.

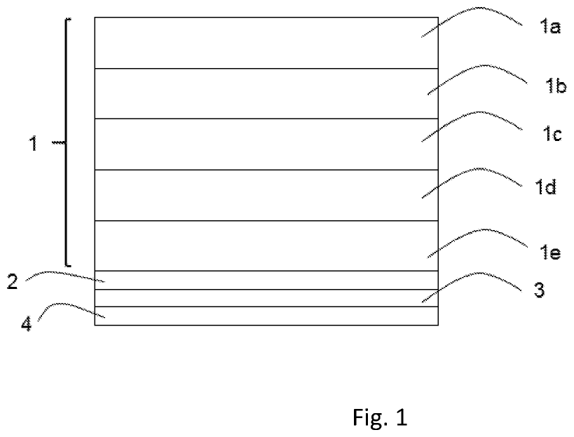

FIG. 1 is a schematic drawing of a paperboard suitable to be used in the production of a container according to one embodiment of the invention.

The paperboard shown in FIG. 1 comprises a fiber based substrate 1, comprising five plies: a top ply (1a) made from 100 wt % bleached sulphate pulp from softwood, a back ply (1e) comprising 100 wt % unbleached sulphate pulp from softwood, a first middle ply (1b) comprising a mixture of bleached sulphate pulp and CTMP and a second and third middle ply (1c, 1d) comprising a mixture of unbleached sulphate pulp and CTMP. The fiber based substrate of the example has been made by first forming the top ply (1a) on a wire on a long base fourdriner. The first, second and third middle ply (1b, 1c, 1d) and the back ply (1e) were thereafter formed successively in the said order on the wet top ply using second, third, fourth and fifth headboxes arranged at distances in the running direction of the web. The multi-ply substrate was thereafter pressed and dried using conventional technique.

The properties of the thereof formed fiber based substrate is shown in Table 1.

TABLE 1

| | |
|---|---|
| Grammage [g/m²] | 215 |
| Thickness [μm] | 299 |
| Moisture [%] | 7 |
| Z-tensile strength [kPa] | 380 |
| Scott Bond [J/m²] | 200 |
| Bending resistance 15° GM [mN] | 115 |
| Bulk [cm³/g] | 1.39 |
| Compression strength (CD)[kN/m] | 3.5 |
| Compression strength (MD) [kN/m] | 5.6 |

The paperboard shown in FIG. 1 further comprises an innermost first barrier layer of polyethylene (2) in direct contact with the back ply (1e), a second barrier layer comprising an aluminum foil (3) and an outermost third barrier layer of polyethylene (4). The polyethylene layers (2, 4) have a thickness of around 15 μm and the aluminum foil (3) has a thickness of around 6 μm. The polymer layers are preferably extrusion coated onto the board, while the aluminum foil is laminated by use of tie layers (not shown) using conventional technology. On the top ply the paperboard may further be provided with coating layers (not shown) suitable for printing. The top ply may further be provided with a barrier layer, such as a polyolefin layer (not shown).

The paperboard described in connection with in FIG. 1 has been shown to be suitable for the manufacturing of tube-formed containers for the packaging of compositions comprising water water-in-oil (W/O) emulsions and/or oil-in-water (O/W) emulsions. Especially, the paperboard has been shown to be suitable for the formation of the tube-formed body of such a container to which a plastic shoulder is attached, without the problems of delamination of the multi-ply board connected to prior art solutions. In addition the paperboard provides the specific barriers needed to pack compositions comprising W/O- or O/W-emulsions. It further provides the required flexibility yet rigidity to be used in such containers.

While the invention has been described with reference to various exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A container for the packaging of compositions comprising water-in-oil (W/O) emulsions and/or oil-in-water (O/W) emulsions, which container comprises;
a tube-formed body made from a paperboard comprising:
a fiber based substrate comprising a first ply forming a back ply, a second ply forming a top ply and a third ply forming at least one middle ply, wherein the fiber based substrate comprises CTMP.

2. A container according to claim 1, wherein the fiber based substrate exhibits a Z-tensile strength of at least 350 kPa and a Scott Bond of at least 180 J/m².

3. A container according to claim 2, wherein the ratio between Scott Bond and Z-tensile strength is between 0.5-1.

4. A container according to claim 1, wherein the fiber based substrate exhibits a bulk of at least 1 cm³/g.

5. A container according to claim 1, wherein the third ply comprises CTMP.

6. A container according to claim 1, wherein the fiber based substrate comprises at least two plies bonded to each other without any adhesive between the at least two plies.

7. A container according to claim 1, wherein the fiber based substrate has been made by first forming a top ply on a wire using a first headbox, whereupon middle and back plies are formed successively on the top ply using a second and a third headbox.

8. A container according to claim 1, wherein the paperboard further comprises at least one barrier layer applied on a first surface of said fiber based substrate.

9. A container according to claim 8, wherein the at least one barrier layer comprises a first innermost barrier layer comprising polyolefin applied on the first surface of the fiber based substrate, a second barrier layer comprising a metal foil and/or ethylene vinyl alcohol (EVOH) and a third, outermost barrier layer comprising polyolefin, which third barrier layer forms an inner surface of the container adapted to be in contact with the content of the container.

10. A method of forming a tube-formed container for the packaging of compositions comprising water water-in-oil (W/O) emulsions and/or oil-in-water (O/W) emulsions, the method comprising:
forming the tube-formed container with paperboard comprising a fiber based substrate comprising a first ply forming a back ply, a second ply forming a top ply and a third ply forming at least one middle ply, wherein the fiber based substrate comprises CTMP.

11. The method according to claim 9, wherein the tube-formed container comprises a tube-formed body and a shoulder and wherein the paperboard is used in the production of the said tube-formed body.

12. The method according to claim 10, wherein the fiber based substrate exhibits a Z-tensile strength of at least 350 kPa and a Scott Bond of at least 180 J/m².

13. The method according to claim 10, wherein the ratio between Scott Bond and Z-tensile strength is between 0.5-1.

14. The method according to claim 10, wherein the fiber based substrate exhibits a bulk of at least 1 cm³/g.

15. The method according to claim 10, wherein the third ply comprises CTMP.

16. The method according to claim 10, wherein the fiber based substrate comprises at least two plies bonded to each other without any adhesive between the at least two plies.

17. The method according to claim 10, wherein the fiber based substrate has been made by first forming the top ply on a wire using a first headbox, whereupon the middle and the back plies are formed successively on the top ply using a second and a third headbox, respectively.

18. The method according to claim 10, wherein the paperboard further comprises at least one barrier layer applied on a first surface of said fiber based substrate.

19. The method according to claim 18, wherein the at least one barrier layer comprises a first innermost barrier layer comprising polyolefin applied on the first surface of the fiber based substrate, a second barrier layer comprising a metal foil and/or ethylene vinyl alcohol (EVOH) and a third, outermost barrier layer comprising polyolefin, which third barrier layer forms an inner surface of the container adapted to be in contact with the content of the container.
